(19) United States
(12) Patent Application Publication
(10) Pub. No.: US 2015/0131274 A1
(43) Pub. Date: May 14, 2015

(54) Solar Powered LED System for Carbon Dioxide Reduction

(71) Applicant: Yung Sheng Liu, Xiandin (TW)

(72) Inventor: Yung Sheng Liu, Xiandian (TW)

(21) Appl. No.: 14/534,567

(22) Filed: Nov. 6, 2014

Related U.S. Application Data
(60) Provisional application No. 61/902,180, filed on Nov. 9, 2013.

(51) Int. Cl. F21S 9/03; F21V 33/00; F21S 8/04; A01G 7/04

(52) U.S. Cl. CPC F21S 9/032; A01G 7/045; F21V 33/006; F21S 8/04
USPC 362/183

(57) ABSTRACT

A net amount of carbon dioxide in earth's atmosphere can be reduced by a system that combines solar panels that are capable of converting sun light into electricity and LED light sources which are tuned to emit photons with wavelength concentrated around 460 nm or 650 nm or around both wavelengths. The LED light sources are configured to be able to direct the emitted photons towards growing plants, which through photosynthesis convert carbon dioxide molecules into bio-mess.

### BACKGROUND

Human activities produce carbon dioxide, so do animal activities. Plants, through photosynthesizing, convert sun light and carbon dioxide in the atmosphere into bio-mess. Today the unbalance is in favor of excess carbon dioxide buildup and the accumulated carbon dioxide gets trapped in the earth atmosphere and is hazardous to the environment.

Efforts are being taken to counter the unbalance, including reduction of energy generation by burning coal, petroleum, natural gas, etc. and in production of more energy efficient home appliances and more fuel efficient automobiles.

On the other hand, plant growth aided by artificial light such as LED lighting has partially supplemented the natural sun light and resulted in more efficient use of natural resources such as land and water. To grow plants in more controlled environment also reduces the consumption of fertilizer and pesticides However, given the fact that it takes power to operate the artificial lighting systems, the net carbon footprints of such systems still tend to be positive, that is, they generate more carbon dioxide as a whole.

### SUMMARY

The Inventor endeavored to invent a novel system and method to reduce the net amount of carbon dioxide from the earth atmosphere.

The Inventor first calculated from the mechanism of photosynthesis the number of photons from sun light it takes convert one CO₂ molecule into bio-mess and compared that to the conversion efficiency of LEDs tuned at certain wavelength ranges. The Inventor discovered that the conversion efficiency of LED emission is about twice that of the natural sun light at around wavelength of 650 nm and 460 mn. That is, it only takes 5 photons of photons from LEDs with the proper wavelengths to convert one CO₂ molecule into bio-mess, it takes ten photons from sun light to do so and to eliminate one CO₂ molecule from earth's atmosphere.

Next, the Inventor calculated the amount of electrical energy necessary to generate the photons form a LED light source of the proper wavelength, The Inventor discovered that one unit of 200 W or 200 units of 1 W LED light source tuned at around 460 nm or at around 650 nm wavelength or both can emit 1.58×10²⁸ photons per year. At the conversion rate of 5:1 the 200 units of 1 W LEDs can reduce from the earth's atmosphere about 1 quarter ton of CO₂ in one year via photosynthesis.

The Inventor then investigated the carbon footprint of known methods of power generation, among them the coal burning plants generate over 1 kg of CO₂ per KWh is the worst. If the LEDs are powered by coal burning plants, for each quarter ton of CO₂ reduced through photosynthesis, almost ten tons of CO₂ will be produced by the power generation process even with the most advanced coal burning technology. Gas plants are also not viable: it emits 345 g of CO₂ to generate one KWh of electricity. At this rate, the result is still more CO₂ generated than eliminated.

Nuclear power plants and wind power do produce electricity more efficiently in term of carbon footprint but nuclear power plants have safety concerns and wind power generation is very location limited. According to the Inventor's study, they too are not viable for CO₂ reduction in large scale implementation.

The Inventor discovered that mass-produced solar cells available today can reach 16% at air mass 1.5 at earth surface. More importantly, the Inventor discovered that it only generates 0.2 tons of CO₂ per year to operate a solar cell to produce 1 KW of electricity.

The Inventor synthesized the information and invented a system that combines the favorable properties of solar cells, which is highly portable and can convert sun light into electricity with low carbon footprint, and the property of LED light sources, which can be tuned to emit photons at around 460 nm and 650 nm to maximize the photosynthesis in plants. The LED light sources can be fabricated to emit photons that are peaked at either 460 nm, 650 nm, or when combined with phosphor coating, emit photons that peak at both 460 nm and 650 nm. This system is uniquely capable of eliminating from earth atmosphere an amount of carbon dioxide more than it takes to manufacture and operate the system. And this is the first man-made system that combines plant's natural capability in a sustainable way to combat the threat of ever increasing damages to the earth environment caused by human activities.

### BRIEF DESCRIPTION OF THE DRAWING FIGURES

FIG. 1 depicts a system comprising a solar panel and an array of LED light source, and an energy storing device.

FIG. 2 depicts a schematic of an apparatus comprising solar panels, arrays of LED light sources, an energy storage device, and a greenhouse.

### DETAILED DESCRIPTION

The following examples describe ways to implement the invention and are only for illustrative purposes. The full scope of the invention is limited only by the claims appending this paper.

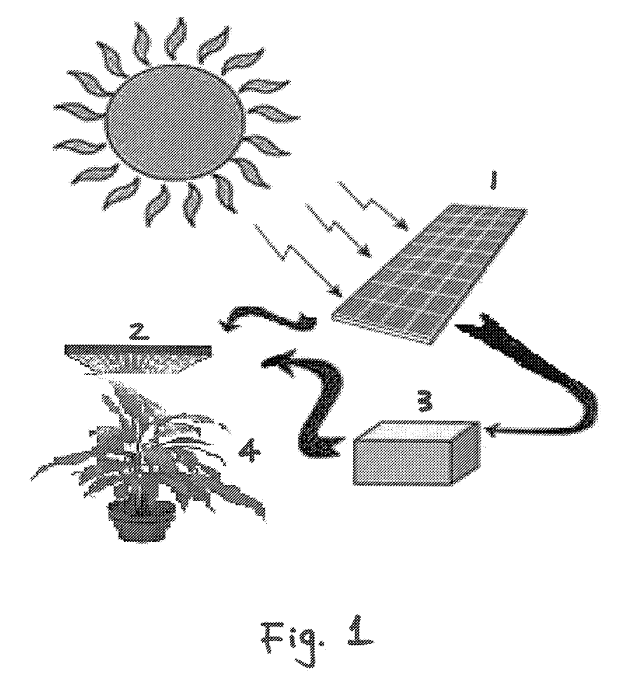

One example, as depicted in FIG. 1, is a system that comprises solar cell panels 1, which may be fabricated with single crystal silicon or polycrystalline silicon, and a LED array 2 with individual LEDs tuned to emit photons with wavelengths peaked in the range of 460 nm or 650 nm or in both ranges. The LED arrays are powered by the solar cell panels directly, or by an energy storage device 3, such as a rechargeable battery, The LED array is depicted as directing the emitted photons towards a growing plant 4.

Silicon solar cell technologies have been advanced steadily in the past decades such that the cost of generating electrical power by solar power is at an acceptable range of a fraction of dollar per kWh. Solar cells made of compound semiconductor material and with multi-junctions have higher conversion efficiency but at a higher cost. As the cost of such more efficient solar cells fall, they too may be viable choice for the system depicted in FIG. 1.

Solar panels can be installed near the plant growing facilities, which make the system uniquely viable for locations that are remote from power grids of other power sources. The panels can be installed on the roof-tops of the plant growing facility which reduces land use and because of the proximity of the panels to the LED light sources reduces power loss that is inevitable with other power generation and distribution methods.

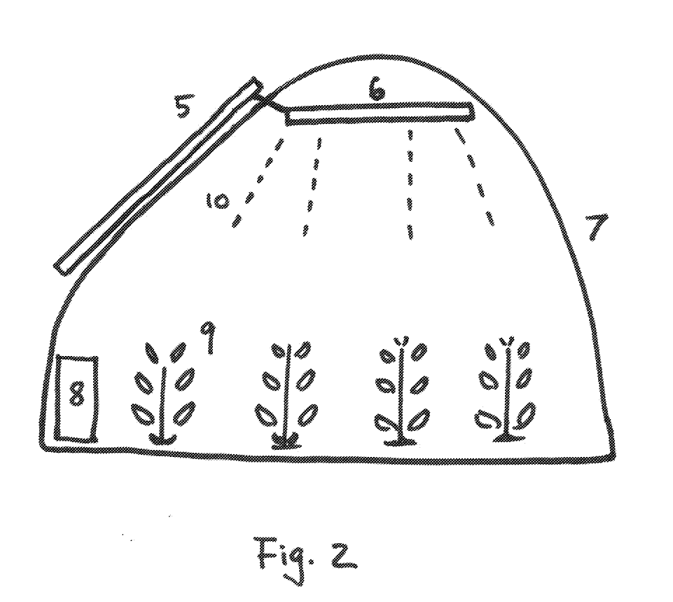

A second example, as depicted in FIG. 2, is a greenhouse 7 suitable for growing plants 9. The greenhouse is equipped with LED light sources 6 tuned to emit photons 10 centered around 460 nm or 650 nm or about both peaks, and with solar panels 6 for powering the LED light sources 6. The greenhouse is also equipped with energy storage devices 8 such as rechargeable batteries that are connected to the solar panels 5 for storing a portion of the power generated by the solar panels. The stored energy can be used to power the LED light sources 6 when sun light is not available to power the LED light sources 6 by the solar panels 5 such as during the night or inadequate such as during nights or cloudy days.

I claim

1. A system comprising:
a solar cell panel operable to generate electrical power when irradiated with sun light; and
a LED light source tuned to emit photons concentrated at a wavelength of about 460 nm or about 650 nm or about both wavelengths upon powered by the electrical power generated in the solar cell panel.

2. The system of claim 1, in which the LED light source is configurable to direct the emitted photons at a growing plant.

3. The system of claim 1, further comprising an energy storing device configured to receive electrical power from the solar cell panel and configured to deliver electrical power to the LED light source.

4. The system of claim 3, in which the energy storing device is a rechargeable battery.

5. The system of claim 3, further comprising a greenhouse, having a roof on the solar cell panel is placed.

6. The system of claim 5, in which the greenhouse is configured inside which to growing plants.

7. The system of claim 5, in which the solar cell panel is configured to receive solar irradiation.
